(19) United States
(12) Patent Application Publication
(10) Pub. No.: US 2025/0189937 A1
(43) Pub. Date: Jun. 12, 2025

(54) METHODS AND DEVICES FOR MANAGING LOAD SHEDDING IN A RESOURCE DISTRIBUTION NETWORK

(71) Applicant: SAGEMCOM ENERGY & TELECOM SAS, BOIS-COLOMBES (FR)

(72) Inventor: Henri TEBOULLE, BOIS-COLOMBES (FR)

(21) Appl. No.: 18/972,458

(22) Filed: Dec. 6, 2024

(30) Foreign Application Priority Data
Dec. 7, 2023 (FR) 2313719
Dec. 7, 2023 (FR) 2313720
Feb. 14, 2024 (FR) 2401442

(51) Int. Cl. G05B 13/02

(52) U.S. Cl. CPC G05B 13/0205

(57) ABSTRACT

Load shedding is implemented in a resource distribution network to avoid overconsumption. The network comprises at least one network head and a plurality of meters configured to measure consumption of said resource by a customer and to transmit to the network head customer information representative of the customer's consumption over a given time range. Based on the customer information transmitted by the meters, a overall forecast consumption is determined for all meters for the specified time period. One or more load-shedding periods are determined by comparing the overall forecast consumption with a predefined overall threshold. For each one, the meters to be load-shed are selected according to the expected load-shedding gains for the meters in question. Furthermore, a load-shedding command is sent to them, concerning one or more future occurrences within the specified time range.

### CROSS-REFERENCE TO RELATED APPLICATIONS

The present application claims priority to French Application No. 2401442 filed with the French National Institute of Industrial Property (INPI) on Feb. 12, 2024; French Application No. 2313719 filed with the French National Institute of Industrial Property (INPI) on Dec. 7, 2023; and French Application No. 2313720 filed with the French National Institute of Industrial Property (INPI) on Dec. 7, 2023, all of which are incorporated herein by reference in their entirety for all purposes.

### TECHNICAL FIELD

The various embodiments described in the present disclosure relate to load shedding in a resource distribution network, for example a distribution network for electricity, gas, water, heat, etc., in order to control demand and avoid overconsumption which could lead to a collapse of the distribution network.

### BACKGROUND

It is known to apply load shedding in an electrical grid when an event leading to insufficient power generation in the network is detected.

There is a need for a method of managing load shedding in a distribution network that responds to variations in demand.

### SUMMARY

According to a first aspect, a method for managing load-shedding is described, which is intended for use in a resource distribution network comprising at least one network head and a plurality of meters and in which the meters are configured to measure consumption of said resource by a customer, transmit to the network head information representative of the customer's consumption, receive a load-shedding command from the network head, and apply load-shedding in accordance with said command. The method further comprises steps for determining, from information representative of customer consumption, a overall forecast consumption over a time range for all the meters; determining one or more load-shedding periods for said time range, by comparing the overall forecast consumption with a predefined overall threshold; estimating a load-shedding gain for at least some of the meters, selecting one or more meters to be load-shed to obtain a target gain making it possible to compensate for a difference between a maximum of the overall forecast consumption over the load-shedding period and the predefined overall threshold, while taking into account the estimated load-shedding gains; sending a load-shedding command to the selected meters, said command relating to one or more future occurrences of said time range and specifying one or more load-shedding periods for said time range.

In one embodiment of the load-shedding management method, the load-shedding gain is estimated for meters where customer consumption exceeds a consumption threshold, or for a percentage of meters where customer consumption is highest.

In one embodiment of the load-shedding management method, the load-shedding gain of a given meter is estimated by comparing information representative of the customer's consumption without load shedding to information, learned during a learning phase, representative of the customer's consumption with load shedding.

For example, during the learning phase, for each time slot considered, a load-shedding command is sent to each meter by time slot, in order to obtain information representative of the customer's consumption with load-shedding, for each time slot of each time range, the load-shedding periods being synchronized to said time slots.

In one embodiment of the load-shedding management method, for example in the case of a gas distribution network, load shedding consists in totally interrupting the distribution of the resource at one or more meters, and the estimated load-shedding gain for a given meter is equal to the customer's consumption without load shedding.

In another embodiment of the load-shedding management method, for example in the case of a water distribution network, load shedding consists in applying a reduced maximum flow rate to one or more meters and, for a given meter, the estimated load-shedding gain is equal to the difference between the customer's consumption without load shedding and the consumption possible with the reduced maximum flow rate.

In one embodiment of the load-shedding management method, the selection of meters for load shedding comprises a random selection, from among the meters for which the load-shedding gain has been estimated, of a number of meters required to achieve the target gain.

In one embodiment of the load-shedding management method, the selection of meters to be load-shed comprises a first selection of a first number of meters greater than the number of meters required to achieve the target gain, and a second random selection from the meters in the first selection of a second number of meters, less than the first number, required to achieve the target gain.

In one embodiment of the load-shedding management method, the selection of meters to be load-shed comprises a first selection from among the meters, taken in order of decreasing load-shedding gain, of a first, second and third group comprising Q1, Q2 and Q3 meters respectively, the sum of the load-shedding gains of the Q1+Q2 meters of the first and second groups enabling the target gain to be achieved, and the sum of the load-shedding gains of the Q2+Q3 meters of the second and third groups enabling the target gain to be achieved; and a second random selection from the Q1+Q2+Q3 meters of Q2+Q3 meters to be load-shed.

In one embodiment of the load-shedding management method, the load-shedding command comprises a number of load shedding periods for said time range and an identifier for each load-shedding period.

In one embodiment of the load-shedding management method, the load-shedding command comprises a number of load shedding periods for said time range, an identifier for each load-shedding period, and an indication of the flow rate reduction to apply.

In one embodiment of the load-shedding management method, only information representative of the customer's consumption without load-shedding is taken into account when determining overall forecast consumption.

According to a second aspect, a network head device is described, which comprises means for implementing a method for managing load shedding in a distribution network as described herein.

According to a third aspect, a load-shedding method is described which is intended to be implemented by a meter belonging to a resource distribution network, the meter being configured to measure a consumption of said resource by a customer and to transmit, to a network head of the distribution network, customer information representative of the customer's consumption over a specified time range. The load-shedding method comprises a step of receiving a load-shedding command from the network head, the load-shedding command specifying one or more load-shedding periods to be implemented during one or more future occurrences of the specified time range.

In one embodiment of the load-shedding method, the load-shedding command comprises a number of load shedding periods for said time range and an identifier for each load-shedding period.

In one embodiment of the load-shedding method, the load-shedding command further comprises an indication of the flow rate reduction to apply at the meter.

In one embodiment of the load-shedding method, load-shedding is initiated and/or terminated at a random time relative to the load-shedding periods specified in the load-shedding command.

According to a fourth aspect, a metering device is described which comprises means for implementing a load-shedding method as described herein.

According to a fifth aspect, a computer program product is described which comprises instructions which when executed by at least one processor cause the implementation of a load-shedding management method as described herein.

According to a sixth aspect, a computer program product is described which comprises instructions which when executed by at least one processor cause the implementation of a load-shedding method as described herein.

According to another aspect, a non-transitory computer-readable storage medium is described, which comprises instructions which when executed by a processor cause the implementation of a load-shedding management method as described herein.

According to another aspect, a non-transitory computer-readable storage medium is described, which comprises instructions which when executed by a processor cause the implementation of a load-shedding method as described herein.

The network head and metering devices can be constituted by software means, i.e. instructions intended to be executed by a set of circuits to perform one or more or all of the operations or steps to be carried out by the network head and/or meter, in application of the methods described herein. The circuit assembly may consist of dedicated circuitry. Alternatively, it may be consist of one or more processors and one or more memories comprising one or more computer program codes, said processors, memories and computer codes being configured to cause the network head and/or meter to execute one or more or all of the steps of the methods described herein.

According to another aspect, a meter management system for a resource distribution network is described. This system comprises at least one network head device and at least one metering device as described herein.

### BRIEF DESCRIPTION OF THE FIGURES

The embodiments will be better understood in light of the following detailed description and the accompanying drawings, which are given by way of illustration only and therefore do not limit the present disclosure.

FIG. 1 shows an example of a meter management system for a resource distribution network.

FIG. 2 shows a plurality of customer load curves over a given time range.

FIG. 3 shows an overall forecast curve over the same specified time range.

FIG. 4 is a diagram describing the steps of a load-shedding management method intended for implementation in a network head of a distribution network.

FIG. 5 describes a particular implementation of the step for selecting the meters to be load-shed in one embodiment.

FIG. 6 is a diagram describing the steps of a load-shedding method intended for implementation in a meter of a distribution network.

FIG. 7 is a block diagram of a device for implementing a network head or meter according to the present disclosure.

### DETAILED DESCRIPTION

Various embodiments will now be described in more detail, by way of non-limiting examples, with reference to the drawings accompanying the present disclosure and illustrating certain exemplary embodiments.

The specific structural and functional details disclosed here are non-limiting examples. The embodiments disclosed here may undergo various modifications and alternative forms. The subject matter of the disclosure may be embodied in many different forms and should not be construed as being limited solely to the embodiments presented herein as illustrative examples. It should be understood that there is no intention to limit the embodiments to the particular forms described in the remainder of this document.

In the following description, identical, similar or analogous elements will be referred to by the same reference numbers. The block diagrams, flowcharts and message sequence diagrams in the figures shows the architecture, functionalities and operation of systems, apparatuses, methods and computer program products according to one or more exemplary embodiments. Each block of a block diagram or each step of a flowchart may represent a module or a portion of software code comprising instructions for implementing one or more functions. According to certain implementations, the order of the blocks or the steps may be changed, or else the corresponding functions may be implemented in parallel. The method blocks or steps may be implemented using circuits, software or a combination of circuits and software, in a centralized or distributed manner, for all or part of the blocks or steps. The described systems, devices, processes and methods may be modified or subjected to additions and/or deletions while remaining within the scope of the present disclosure. For example, the components of a device or system may be integrated or separated. Likewise, the features disclosed may be implemented using more or fewer components or steps, or even with other components or by means of other steps. Any suitable data-processing system can be used for the implementation. An appropriate data-processing system or device comprises for example a combination of software code and circuits, such as a processor, controller or other circuit suitable for executing the software code. When the software code is executed, the processor or controller prompts the system or apparatus to implement all or part of the functionalities of the blocks and/or steps of the processes or methods according to the exemplary embodiments. The software code can be stored in non-volatile memory or on a non-volatile storage medium (USB key, memory card or other medium) that can be read directly or via a suitable interface by the processor or controller.

The present disclosure applies to any resource distribution network comprising at least one network head and a plurality of meters measuring the consumption of said resource. For example, this could be a network for distributing electricity, gas, water, heat, etc. Some embodiments are optimized for the distribution of a particular resource, without this being exclusive of other resources.

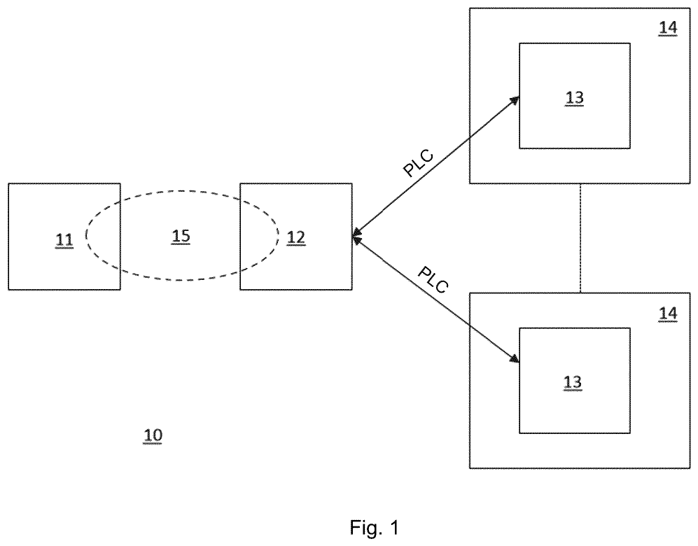

In the non-limiting example shown in FIG. 1, a meter management system 10 for a distribution network comprises at least one network head 11 which is designed to communicate via a sub-distributor 12 with a plurality of meters 13 installed on customer 14 premises. For example, the network head 11 communicates with the sub-distributor 12 via a wireless telecoms network 15. The wireless communication network 15 can be a GPRS, UMTS, LTE, 5G or narrowband IoT (Internet-of-Things) network. For example, the sub-distributor 12 communicates with the meters 13 via the electrical network using power line communication (PLC).

A meter 13 installed n customer 14 premises is configured to measure consumption by the customer 14 of the resource distributed via the distribution network. For example, when the network is an electricity, gas or water distribution network, the meter 13 measures the electricity, gas or water consumption of the customer 14.

The meters 13 are also configured to transmit customer information to the network head 11, representative of the consumption by the customer 14 over a given period of time. For example, the meters 13 transmit information representative of daily consumption. This customer information comprises, for example, a consumption value per time slot of a given duration, for example every 15 minutes. The values transmitted for each 15-minute time slot during the day are used to establish a load curve for the customer for the day.

The network head 11 is configured to transmit load-shedding commands to one or more meters 13.

The meters 13 are configured to perform load shedding, in accordance with the load shedding commands they receive from the network head 11. For example, in an electricity distribution network, a meter 13 can perform load shedding by disconnecting one or more electricity-consuming elements on customer 14 premises, for example a hot water tank and/or one or more radiators. This kind of load shedding reduces consumption and thus avoids the risk of the distribution network collapsing. For example, in a gas distribution network, load shedding can be achieved by completely interrupting gas distribution during the load-shedding period. For example, in a water distribution network, load shedding can be achieved by reducing the maximum flow rate of water that can be consumed by the customer during the load-shedding period.

For example, data is exchanged between the meters 13 and the network head 11 using DLMS/COSEM-compliant data frames.

In the embodiments described below by way of example, a given time slot corresponds to a specific day of the week (i.e. Sunday, Monday, etc.). The network head 11 then separately stores customer information for each day of the week. In this way, differences in consumption profiles depending on the day of the week can be taken into account.

Other embodiments are possible, using other specified time ranges. For example, a given time range can correspond to any working day or any non-working day. In this case, the network head 11 stores both customer information for working days and customer information for non-working days. In another example, the specified time range corresponds to a specific week or month of the year. In this case, the network head 11 stores customer information for each individual week or month of the year. In this example, it is possible to take into account differences in consumption profiles according to vacation weeks or seasons of the year.

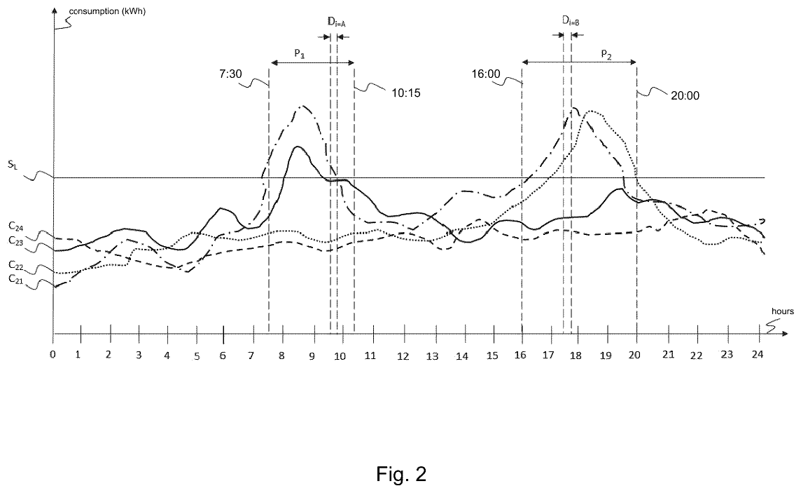

FIG. 2 shows the load curves of four customers C₂₁, C₂₂, C₂₃ and C₂₄ over a specified time range, which in this example corresponds to a given day of the week (day D). In this example, we assume that the day D for which customer information has been collected is a day without load shedding for customers C₂₁ to C₂₄.

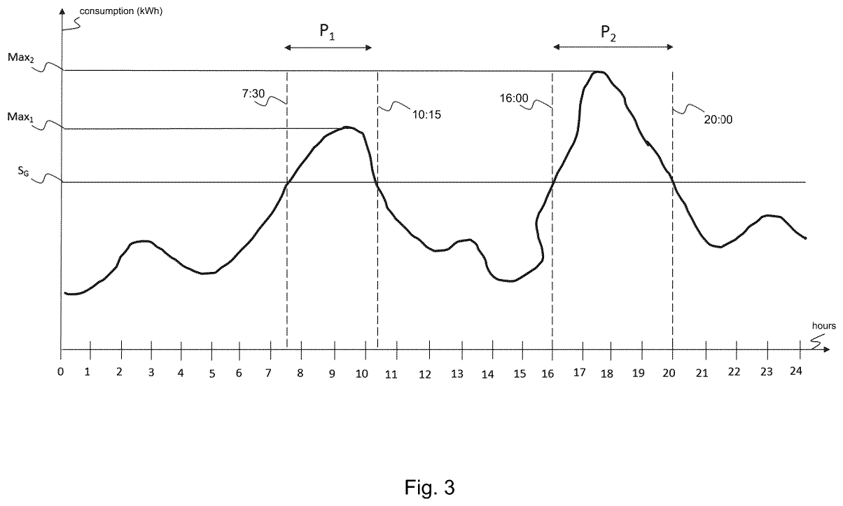

FIG. 3 shows a forecast curve representing overall forecast consumption, obtained for the same time range, i.e. for day D, from the load curves of the four customers shown in FIG. 2.

FIG. 3 shows a threshold S_{G}, known as the predefined overall threshold, which corresponds to a theoretical maximum consumption for all customers C₂₁ to C₂₄. FIG. 3 shows that the S_{G} predefined overall threshold is exceeded during two periods, known as overconsumption periods, P₁ between 7:30 and 10:15 and P₂ between 16:00 and 20:00. The maximum consumption during the period of overconsumption P₁ is denoted Max₁ and the maximum consumption during the period of overconsumption P₂ is denoted Max₂.

Each period of overconsumption may give rise to one or more periods of load shedding. For example, a period of overconsumption may constitute a single load-shedding period or may correspond to a plurality of load-shedding periods.

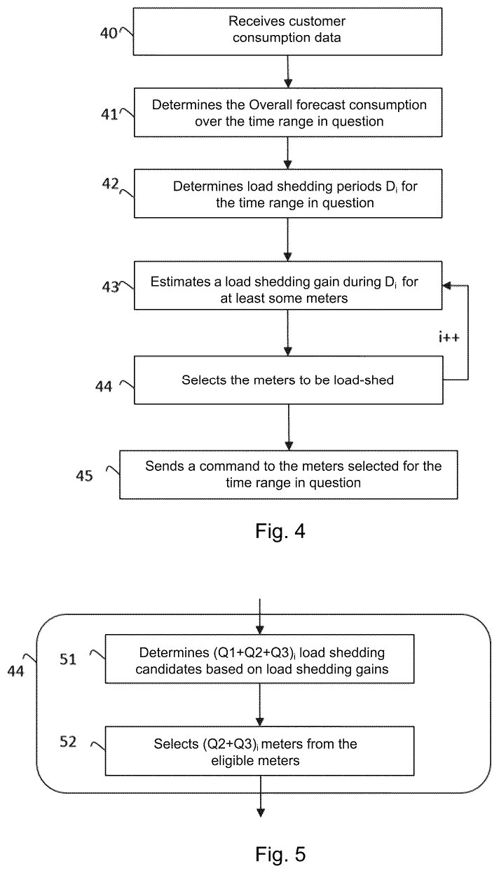

FIG. 4 is a flowchart showing the main stages of a load-shedding management method to be implemented by the network head 11. In step 40, the network head 11 receives customer information from a plurality of meters 13 in the distribution network 11, representative of the customer's consumption over a given period of time (e.g. one day D of the week). In step 41, the network head 11 uses the information representing customer consumption to determine an overall forecast consumption over the time period for all the meters. In step 42, the network head 11 determines one or more Dᵢ load-shedding periods from the customer information received. In step 43, the network head 11 estimates a load-shedding gain on Dᵢ for at least some of the meters 13. In step 44, the network head 11 selects the meters to be load-shed, taking into account the load-shedding gains obtained in the previous step. In step 45, the network head 11 sends a load-shedding command to the selected meters for one or more future occurrences of the specified time range (e.g. for day D of the following week).

The load-shedding gain can be estimated for all or some of the meters 13 controlled by the network head 11. In the remainder of the description, the meters for which the load-shedding gain is estimated are referred to as load-shedding-eligible meters.

For example, eligible meters are made up of a given percentage of meters with the highest consumption without load shedding (for example, the 50% or 75% of meters of customers with the highest consumption, based on consumption information received by the network head 11).

In another example, eligible meters are those for which customer consumption exceeds a given consumption threshold. This consumption threshold may be a theoretical maximum (in the case of an electricity meter, for example) or may correspond to the maximum consumption possible when the meter applies a load-shedding command (in the case of a water meter, for example). FIG. 2 shows an example of the consumption threshold SL. The periods of overconsumption P₁ and P₂ in FIG. 3 are shown in FIG. 2. We can thus see that the customers who exceed the consumption threshold SL during the overconsumption period P₁ are customers C₂₁ and C₂₃. Furthermore, the customers who exceed the consumption threshold SL during the overconsumption period P₂ are customers C₂₁ and C₂₂. In other words, in this example: customer C₂₁ is eligible during the two overconsumption periods P₁ and P₂; customer C₂₂ is eligible during the overconsumption period P₂; customer C₂₃ is eligible during the overconsumption period P₁; and customer C₂₄ is not eligible.

In step 43, the load-shedding gain is estimated for meters eligible for load shedding. This can be done in a variety of ways. For example, the estimated load-shedding gain may vary according to the type of resource distributed.

In a first example, the distributed resource is gas. In this case, load shedding can be achieved by completely interrupting gas distribution to certain customers. The estimated load-shedding gain for a given meter is then equal to the customer's consumption when no load shedding is applied.

In a second example, the distributed resource is water, and load shedding can be achieved by applying a reduced maximum flow rate to one or more meters. In this case, the estimated load-shedding gain for a given meter is equal to the difference between the customer's consumption without load-shedding and the consumption possible with the maximum reduced flow.

In a third example, the distributed resource is electricity. In this case, load shedding can be achieved by disconnecting one or more electricity-consuming elements on the customer's premises. The network head can then learn the impact of load shedding for each meter during a learning phase and estimate the load-shedding gain from the information learned. This learning process is independent of load-shedding requirements. It can be done once or regularly, for example every year, once in summer and once in winter. The learning is done on real data. For example, during the learning phase, for each time slot considered, a load-shedding command is sent to each meter by time slot, in order to obtain information representative of the customer's consumption with load-shedding, for each time slot of each time range. For example, when the time range under consideration corresponds to a specific day of the week, a load-shedding command is sent to all meters every 15 minutes for each specific day of the week, in order to learn how meters respond to load-shedding commands. For example, if the time range considered is a day, it can be divided into 96 time slots of 15 minutes each.

In step 44, the network head selects the meters to be load-shed to obtain a target gain that compensates for the difference between the maximum overall forecast consumption over the shedding period and the predefined overall threshold, taking into account the shedding gains estimated in step 43.

For example, the network head selects the meters to be load-shed to achieve the target gain by considering the shedding gains of eligible meters in descending order of shedding gain. For example, the network head adds up the load-shedding gains of the meters in descending order until the target gain is achieved, and selects the corresponding meters for load-shedding. This embodiment makes it possible to target those customers for whom load shedding will have the greatest impact.

In another example, the network head selects the meters to be load-shed to achieve the target gain by considering the load-shedding gains of eligible meters taken at random. For example, the network head adds up the load-shedding gains of meters chosen at random until the target gain is achieved, and selects the corresponding meters for load-shedding. This means that the same customers are not always affected.

In another example, the network head performs a first selection, based on the load-shedding gains of eligible meters, of a number of meters greater than the number of meters required to achieve the target gain, and then performs a second selection, from among the meters of the first selection, to achieve the target gain. The second selection, for example, is random. This embodiment makes it possible to target those customers for whom load shedding will have the greatest impact, while avoiding always selecting the same customers.

The random selections described above can incorporate other parameters such as the customer's subscription type, or the customer's load-shedding history.

When the meters are gas meters, load shedding is carried out by completely interrupting distribution. It is possible to assume that all meters are eligible, and to select meters randomly by adding up their load-shedding gain until the target gain is achieved.

When the meters are water meters, advantageously only some of the meters are considered eligible. For example, the eligible meters are made up of the 75% of meters with the highest consumption, or meters whose consumption is higher than the consumption possible with load shedding (i.e. when the flow rate is reduced). In other words, only those meters whose consumption is high enough for load shedding to have a significant impact are considered. The eligible meters can then be selected at random, as described above for gas.

FIG. 5 shows an example of how the selection step 44 can be implemented, particularly in the case of electricity meters. In this example, the step 44 is divided into two steps 51 and 52. In step 51, the network head 11 determines a first, second, and third group of eligible meters, in descending order of load-shedding gain, comprising Q1, Q2 and Q3 eligible meters respectively, such that the sum of the load-shedding gains of the Q1+Q2 meters in the first and second groups enables the target gain to be achieved, and the sum of the load-shedding gains of the Q2+Q3 meters in the second and third groups enables the target gain to be achieved. In step 52, a selection of Q2+Q3 meters to be offloaded is then made from the Q1+Q2+Q3 meters determined in step 51, for example at random. For example, the Q1+Q2 meters of the first and second groups are obtained by adding the load-shedding gains of the meters in descending order until the target gain is achieved. Next, the Q2+Q3 meters of the second and third groups are obtained by adding up the load-shedding gains of the meters in descending order from the start of the second group until the target gain is achieved.

In step 45, the network head 11 sends a load-shedding command to the selected meters for at least one future occurrence of the time range in question (e.g. day D of one or more subsequent weeks). Using the example of FIG. 2, and assuming that the meters selected in step 44 are the meters of customers C₂₁ and C₂₂, the command sent to the meter of the customer C₂₁ specifies two load-shedding periods D₁ and D₂, and the command sent to the meter of the customer C₂₂ specifies one load-shedding period D₂.

In a first embodiment, the load-shedding command comprises a start indication T_{d} and an end indication T_{f} (or alternatively a duration indication) for each load-shedding period of the specified time range. For example, this command is transmitted in a DLMS/COSEM data frame as a COSEM object with a load-shedding OBIS code, i.e. a “Limiter” object with the OBIS code shown in the table below:

OBIS code

| Object | IC | A | B | C | D | E | F |
|---|---|---|---|---|---|---|---|
| Limiter | 71, limiter | 0 | b | 17 | 0 | e | 255 |

The data frame comprises a field containing the payload data. This field comprises, for example:
one byte to indicate the number of load-shedding periods applicable to the meter for which the command is intended;
for each load-shedding period, one byte to indicate the hour and one byte to indicate the minute when the load-shedding starts; and one byte to indicate the hour and one byte to indicate the minute when the load-shedding ends.

Advantageously, it is ensured that all meters involved in the same load-shedding period do not start load shedding at exactly the same time, and do not stop load shedding at exactly the same time. This would lead to load changes that would be detrimental to the balance of the distribution network.

In a first example, the commands sent to the various meters contain start indications T_{d} for the same load-shedding period that are offset in time from one another. For example, the meter of the customer C₂₁ receives a command to start load shedding with a start indication at 4:00 μm and an end indication at 8:00 pm for the period P₂. Furthermore, the meter of the customer C₂₂ receives a command to start load shedding with a start indication at 16:01, offset by one minute for the same period P₂. If the order contains an end indication, this is shifted by the same amount of time (so in this example, the end indication is equal to 20:01 for the meter of the customer C₂₂).

In another example, the start and end indications T_{d} and T_{f} are the same for all selected meters. Furthermore, each meter starts and stops load shedding according to a random variable managed by the meter, which implies a start and an end at a random time within an interval around the start T_{d} and end T_{f} indications respectively. For example, each meter starts load shedding randomly in the interval [T_{d}−2′30″; T_{d}+2′30″] and stops doing it randomly in the interval [T_{f}−2′30″; T_{f}+2′30″].

In another embodiment, the load-shedding command sent in step 45 comprises an indication of a number of load-shedding periods for the time range concerned, as well as an identifier for each of the load-shedding periods. For example, if the time range corresponds to one day, and the load-shedding periods are set at 15 minutes, there are 96 possible load-shedding periods over the day. The order will indicate how many load-shedding periods are planned for the order recipient, and during which of the 96 possible periods the load-shedding will take place. In this embodiment, advantageously, each meter starts and stops load shedding according to a random variable managed by the meter which implies a start and an end at a random time relative to the start and end of the load-shedding period.

In the examples just described, the command is binary. In fact, it only indicates whether or not to load-shed. Alternatively, the order can specify one or more load-shedding levels applicable to the entire order or to each load-shedding period. For example, in the case of water distribution, the load-shedding command can also indicate the maximum reduced flow rate or the percentage reduction in the maximum flow rate. In the case of an electricity network, and in the event of customer installations with a plurality of load-shedding circuits, the command can also indicate various load-shedding levels.

In the embodiment with the learning phase, the load-shedding periods are preferably synchronized to the time slots used during the learning phase. The easiest way is to use learning time slots and load-shedding periods of the same duration (e.g. 15 min.). It is also possible to use load-shedding periods whose duration is a multiple of the learning time slots. Thus, the periods of overconsumption P1 and P2 shown in FIG. 2 and FIG. 3 correspond to one or more periods of load shedding Di. FIG. 2 shows, by way of example, two load-shedding periods corresponding to two learning time slots: a load-shedding period Di=A which is part of the first overconsumption period P1 and runs between 9:30 and 9:45 a.m., and a load-shedding period Di=B which is part of the second overconsumption period P2 and runs between 5:30 and 5:45 p.m. (with 0<A<B≤96). FIG. 2 shows that during the load-shedding period Di=A, only customer C21 is eligible for load shedding. During the Di=B load-shedding period, customers C21 and C22 are both eligible.

For example, to determine overall forecast consumption and to determine which customers are eligible for load shedding, only information representative of the customer's consumption in non-load-shedding mode is taken into account. For example, if the customer has been subject to load shedding on day D of the current week, the network head 11 uses the information for the last day D that was not subject to load shedding for this customer (instead of using the information transmitted for day D of the current week).

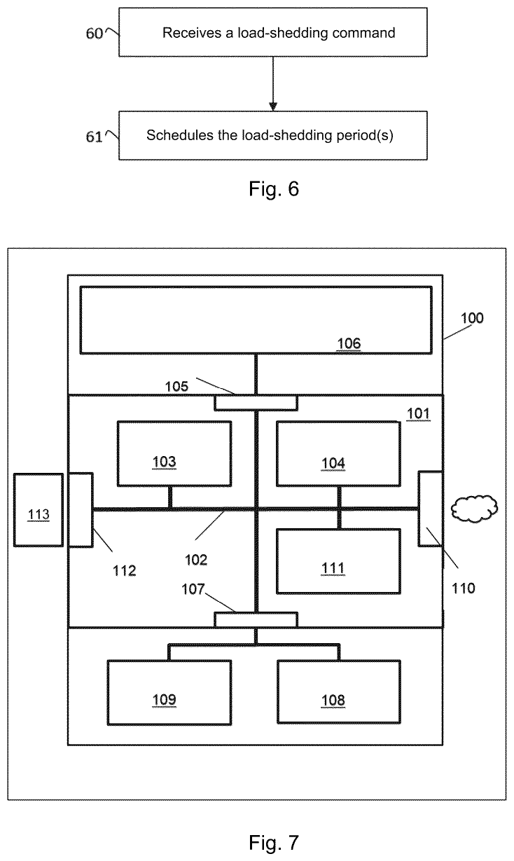

FIG. 6 is a flowchart showing the main stages of a load-shedding method to be implemented by a meter of the distribution network. In step 60, the meter receives the command transmitted by the network head in step 45. In step 61, the meter reads the contents of the command and programs one or more load-shedding operations based on the load-shedding start and end indications contained in the command.

In one embodiment, the meter programs the load shedding(s) so that they are triggered and/or stopped according to a random variable managed by the meter that implies a start and end of load shedding at a random time relative to the start and end of the load-shedding period specified in the load-shedding command.

The network head 11 and the meters 13 can, for example, be implemented in the form of a device as shown in FIG. 7. This device referenced 100 comprises a printed circuit board 101 on which a communication bus 102 connects a processor 103, a random access memory 104, a storage medium 111, optionally an interface 105 for connecting a display 106, a series of connectors 107 for connecting user interface devices or modules such as a mouse or trackpad 108 and a keyboard 109, a wireless network interface 110 and/or a wired network interface 112. Depending on the functionality required, in particular whether the device 100 is being used in a network head 11 or a meter 13, the device may implement only some of the foregoing. For example, a meter 13 is not usually connected to a mouse, trackpad or keyboard, nor to a wireless or wired network, as information exchanges with the meter are usually carried out by powerline communication. Some of the modules shown in FIG. 7 may be internal or externally connected, in which case they are not necessarily an integral part of the device itself. For example, the display 106 may be a display that is only connected to the device 100 in specific circumstances, or the device 100 may be controlled by another device with a display, in which case the device 100 has no display 106 or interface 105.

The memory 111 contains one or more software codes which, when executed by the processor 103, enable the network head 11 to perform the load-shedding management method disclosed herein. In one example, a removable storage medium 113, such as a USB key, can also be connected. For example, the detachable storage medium 113 may contain software codes to be downloaded into the memory 111.

The processor 103 can be any type of processor such as a central processing unit (“CPU”) or a dedicated microprocessor such as an integrated microcontroller or digital signal processor (“DSP”).

The device 100 may also comprise other components typically found in computer systems, such as an operating system, queue managers, device drivers, or one or more network protocols that are stored in memory 111 and executed by the processor 103.

The person skilled in the art will understand that all the block diagrams presented here represent conceptual views, given by way of example, of circuits incorporating the principles of the disclosure.

Each function, block, and step described can be implemented in hardware, software, firmware, middleware, microcode or any suitable combination thereof. If implemented in software, the functions or blocks of the block diagrams and flowcharts can be implemented by computer program instructions/software codes, which can be stored or transmitted on a computer-readable medium, or loaded onto a general-purpose computer, special-purpose computer or other programmable processing device and/or system, so that the computer program instructions or software code running on the computer or other programmable processing device create the means for implementing the functions described in this description.

Although aspects of this disclosure have been described with reference to specific achievements, it should be understood that these achievements merely illustrate the principles and applications of this disclosure. It is therefore understood that numerous modifications can be made to the illustrative embodiments and that other arrangements can be devised without departing from the spirit and scope of the disclosure as determined on the basis of the claims and their equivalents.

Advantages and solutions to problems have been described above with regard to specific embodiments of the invention. However, advantages, benefits, solutions to problems, and any element which may cause or result in such advantages, benefits or solutions, or cause such advantages, benefits or solutions to become more pronounced shall not be construed as a critical, required, or essential feature or element of any or all of the claims.

1. A method for managing load shedding in a resource distribution network, the network comprising at least one network head and a plurality of meters configured to:
measure a customer's consumption of said resource,
send the network operator information representative of the customer's consumption,
receive a load-shedding command from the network head and apply load-shedding according to said command,
characterized in that the method comprise steps for:
determining, from information representing customer consumption, an overall forecast consumption over a period of time for all meters,
determining one or more load-shedding periods for said time range, by comparing the overall forecast consumption with a predefined overall threshold, estimating a load-shedding gain for at least some of the meters,
selecting one or more meters for load shedding to obtain a target gain that compensates for a difference between a maximum of the overall forecast consumption over the load-shedding period and the predefined overall threshold, taking into account the estimated load-shedding gains,
sending a load-shedding command to the selected meters, said command relating to one or more future occurrences of said time range and specifying one or more load-shedding periods for said time range.

2. The method for managing load shedding according to claim 1, characterized in that the load-shedding gain is estimated for meters where customer consumption exceeds a consumption threshold or for a percentage of meters where customer consumption is highest.

3. The method for managing load shedding according to claim 1, characterized in that the load-shedding gain of a given meter is estimated by comparing information representative of the customer's consumption without load shedding to information, learned during a learning phase, representative of the customer's consumption with load shedding.

4. The method for managing load shedding according to claim 3, characterized in that during the learning phase, for each time slot considered, a load-shedding command is sent to each meter by time slot, in order to obtain information representative of the customer's consumption with load-shedding, for each time slot of each time range, the load-shedding periods being synchronized to said time slots.

5. The method for managing load shedding according to claim 1, characterized in that the load shedding consists in totally interrupting the distribution of the resource at one or more meters, and the estimated load-shedding gain for a given meter is equal to the customer's consumption without load shedding.

6. The method for managing load shedding according to claim 1, characterized in that the load shedding consists in applying a reduced maximum flow rate to one or more meters and, for a given meter, the estimated load-shedding gain is equal to the difference between the customer's consumption without load shedding and the consumption possible with the reduced maximum flow rate.

7. The method for managing load shedding according to claim 1, characterized in that the selection of meters for load shedding comprises a random selection, from among the meters for which the load-shedding gain has been estimated, of a number of meters required to achieve the target gain.

8. The method for managing load shedding according to claim 1, characterized in that the selection of meters to be load-shed comprises:
a first selection of a first number of meters greater than the number of meters required to achieve the target gain, and
a second random selection from the meters in the first selection, of a second number of meters, less than the first number, required to achieve the target gain.

9. The method for managing load shedding according to claim 1, characterized in that the selection of meters to be load-shed comprises:
a first selection of a first, second and third group, comprising Q1, Q2 and Q3 meters respectively, from the meters taken in order of decreasing load-shedding gain, the sum of the load-shedding gains of the Q1+Q2 meters of the first and second groups making it possible to achieve the target gain, and the sum of the load-shedding gains of the Q2+Q3 meters of the second and third groups making it possible to achieve the target gain,
a second random selection from the Q1+Q2+Q3 meters of Q2+Q3 meters to be load-shed.

10. The method for managing load shedding according to claim 1, characterized in that the load-shedding command comprises a number of load shedding periods for said time range and an identifier for each load-shedding period.

11. The method for managing load shedding according to claim 4, characterized in that the load-shedding command comprises a number of load shedding periods for said time range, an identifier for each load-shedding period, and an indication of the flow rate reduction to apply.

12. The method for managing load shedding according to claim 1, characterized in that only information representative of the customer's consumption without load shedding is taken into account when determining the overall forecast consumption.

13. A network head device comprising means for implementing a method for managing load shedding in a distribution network according to claim 1.

14. A method for load shedding by a meter belonging to a resource distribution network, the meter being configured to measure a consumption of said resource by a customer and to transmit, to a network head of the distribution network, customer information representative of the customer's consumption over a specified time range, the method comprising a step of receiving a load-shedding command from the network head, the load-shedding command specifying one or more load-shedding periods to be implemented during one or more future occurrences of the specified time range.

15. The method for load shedding according to claim 14, characterized in that the load-shedding command comprises a number of load shedding periods for said time range and an identifier for each load-shedding period.

16. The method for load shedding according to claim 15, characterized in that the load-shedding command further comprises an indication of the flow rate reduction to be applied at the meter.

17. The method for load shedding according to claim 14, characterized in that the load shedding is initiated and/or terminated at a random time relative to the load shedding periods specified in the load-shedding command.

18. The metering device comprising means for implementing a load-shedding method according to claim 14.

19. A computer program product comprising instructions which when executed by at least one processor cause the implementation of a load-shedding management method according to claim 1.

20. The computer program product comprising instructions which when executed by at least one processor cause the implementation of a load-shedding method according to claim 14.

21. A non-transitory computer-readable storage medium comprising instructions which when executed by a processor cause the implementation of a load-shedding management method according to claim 1.

22. A non-transitory computer-readable storage medium comprising instructions which when executed by a processor cause the implementation of a load-shedding management method according to claim 14.

23. A system for managing meters in a resource distribution network, comprising at least one network head device according to claim 13, and at least one metering device comprising means for implementing a load-shedding method comprising a step of receiving a load-shedding command from the network head, the load-shedding command specifying one or more load-shedding periods to be implemented during one or more future occurrences of the specified time range.
